(19) United States
(12) Patent Application Publication
(10) Pub. No.: US 2026/0241911 A1
(43) Pub. Date: Aug. 20, 2026

(54) ELECTRIC BRAKE APPARATUS

(71) Applicant: Astemo, Ltd., Tokyo (JP)

(72) Inventor: Koichi SAKIMOTO, Ibaraki (JP)

(21) Appl. No.: 19/159,844

(22) PCT Filed: Mar. 12, 2024
(86) PCT No.: PCT/JP2024/009453

§ 371 Date: Aug. 26, 2025

(30) Foreign Application Priority Data
Jun. 22, 2023 (JP) 2023-102521

(51) Int. Cl. B60T 13/74; B60T 1/06

(52) U.S. Cl. CPC B60T 13/746; B60T 1/065

(57) ABSTRACT

-26 The present invention provides an electric brake apparatus including a parking brake mechanism excellent in controllability, and achieving a simple structure as well as a size reduction. A parking brake mechanism provided to a disk brake includes a solenoid actuator serving as a switch mechanism that moves a large-diameter gear of a second speed reduction gear and a first speed reduction gear relative to each other along an axial direction thereof, and is configured to generate or eliminate a gap between a tooth thickened portion of the large-diameter gear of the second speed reduction gear and each tooth portion of the first speed reduction gear 34 by actuating the solenoid actuator. Due to that, this parking brake mechanism is excellent in controllability, and can achieve a simple structure as well as a size reduction,

### TECHNICAL FIELD

The present invention relates to an electric brake apparatus used to brake a vehicle.

### BACKGROUND ART

For example, a disk brake (an electric brake apparatus) disclosed in PTL 1 is configured in the following manner. When a parking brake is actuated, electric power is supplied to a solenoid actuator, and this causes a plunger of the solenoid actuator to retract to allow a claw portion of a holding member to move toward an outer peripheral surface of a ratchet gear against a biasing force of a compression coil spring, thereby engaging a gear portion of the ratchet gear to maintain a braking state. At this time, the gear portion of the ratchet gear and the claw portion of the holding member may fail to be engaged due to interference of the respective top portions with each other, and therefore an electric motor is rotated in a braking release direction to align their positions with each other, thereby ensuring engagement between the gear portion of the ratchet gear and the claw portion of the holding member.

### CITATION LIST

### Patent Literature

PTL 1: Japanese U.S. Patent No. 7220281

### SUMMARY OF INVENTION

### Technical Problem

However, the above-described disk brake disclosed in PTL 1 necessitates stepwise actuation of the solenoid actuator and the electric motor to align the gear portion of the ratchet gear and the claw portion of the holding member when actuating the parking brake, thereby complicating control thereof and leaving a problem with controllability. Another example of problems lying in the above-described disk brake disclosed in PTL 1 is that the ratchet gear, the holding member, the engagement member, the compression coil spring, and the like should be provided as a parking brake mechanism, and therefore the structure and the layout thereof are significantly complicated and also grow in size.

Then, in consideration of the above-described problems, one of objects of the present invention is to provide an electric brake apparatus including a parking brake mechanism excellent in controllability, and achieving a simple structure as well as a size reduction.

### Solution to Problem

As a means for solving the above-described problems, an electric brake apparatus according to one aspect of the present invention includes an electric motor, a speed reduction mechanism configured to power up a rotational torque fed from the electric motor, and a parking brake mechanism configured to hold a pressing force for pressing a braking member toward a braking receiving member by converting a rotation fed from the speed reduction mechanism into a linear motion. The speed reduction mechanism includes a first gear and a second gear meshed with the first gear. A gap is generated along a rotational direction between a tooth portion of the first gear and a tooth portion of the second gear. The parking brake mechanism includes a switch mechanism configured to move the first gear and the second gear relative to each other along an axial direction thereof. The electric brake apparatus is configured to generate or eliminate the gap based on actuation of the switch mechanism.

The parking brake mechanism provided to the electric brake apparatus according to the one aspect of the present invention is excellent in controllability, and can achieve a simple structure as well as a size reduction.

### BRIEF DESCRIPTION OF DRAWINGS

FIG. 1 is a partial cross-sectional view of a disk brake according to an embodiment of the present invention.

FIG. 2 is an enlarged cross-sectional view of main portions of the disk brake according to the present embodiment.

FIG. 3 is an exploded perspective view of a parking brake mechanism employed in the disk brake according to the present embodiment.

FIG. 4 is a perspective view of the parking brake mechanism employed in the disk brake according to the present embodiment.

FIG. 5 is a cross-sectional view illustrating that a plunger of a solenoid actuator is mounted on a second speed reduction gear employed in the disk brake according to the present embodiment.

FIG. 6 is a radially perpendicular cross-sectional view illustrating each tooth portion including a tooth thickened portion in a large-diameter gear of the second speed reduction gear employed in the disk brake according to the present embodiment.

FIG. 7 is a radially perpendicular cross-sectional view illustrating that each tooth portion including the tooth thickened portion in the large-diameter gear of the second speed reduction gear employed in the disk brake according to the present embodiment, and each tooth portion of a first speed reduction gear are meshed with each other.

FIG. 8 is a radially perpendicular cross-sectional view illustrating that the second speed reduction gear moves axially relative to the first speed reduction gear due to actuation of the solenoid actuator from the state illustrated in FIG. 7.

FIG. 9 is a cross-sectional view of a switch mechanism according to a second embodiment.

FIG. 10 is a radially perpendicular cross-sectional view illustrating that each tooth portion including a tooth thickened portion according to another embodiment in the large-diameter gear of the second speed reduction gear, and each tooth portion of the first speed reduction gear are meshed with each other.

FIG. 11 is a radially perpendicular cross-sectional view illustrating that the second speed reduction gear moves axially relative to the first speed reduction gear due to actuation of the solenoid actuator from the state illustrated in FIG. 10.

FIG. 12 is a radially perpendicular cross-sectional view illustrating that each tooth portion including a tooth thickened portion according to further another embodiment in the large-diameter gear of the second speed reduction gear, and each tooth portion of the first speed reduction gear are meshed with each other.

FIG. 13 is a radially perpendicular cross-sectional view illustrating that the second speed reduction gear moves axially relative to the first speed reduction gear due to actuation of the solenoid actuator from the state illustrated in FIG. 12.

FIG. 14 is a radially perpendicular cross-sectional view illustrating that each tooth portion including a tooth thickened portion according to further another embodiment in the large-diameter gear of the second speed reduction gear, and each tooth portion of the first speed reduction gear are meshed with each other.

FIG. 15 is a radially perpendicular cross-sectional view illustrating that the second speed reduction gear moves axially relative to the first speed reduction gear due to actuation of the solenoid actuator from the state illustrated in FIG. 14.

### DESCRIPTION OF EMBODIMENTS

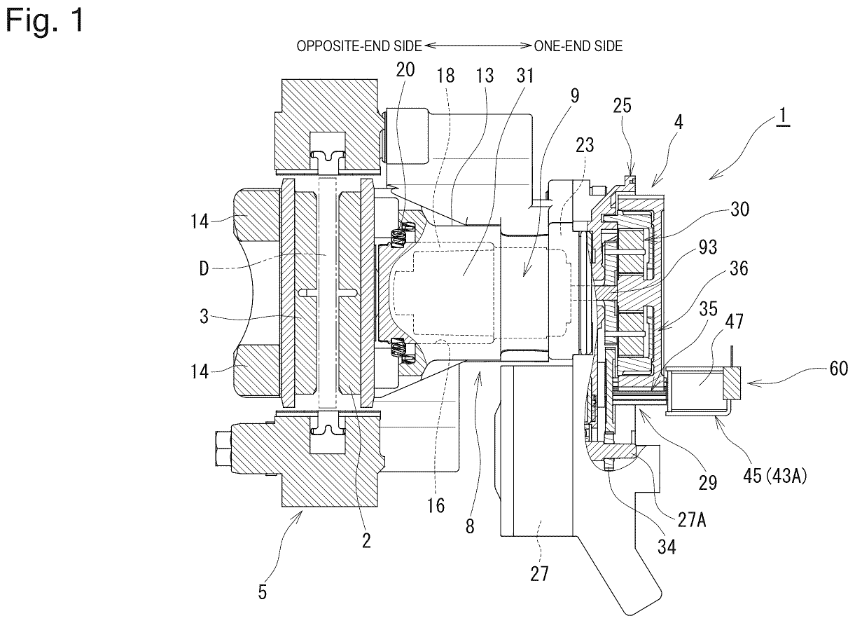

In the following description, embodiments of the present invention will be described in detail with reference to FIGS. 1 to 15.

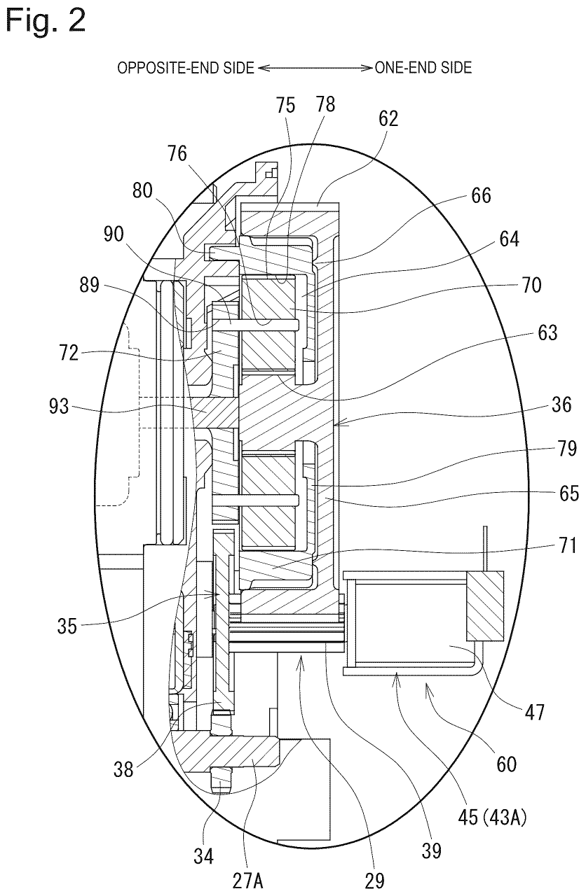

An electric brake apparatus according to the present embodiments, more specifically, a disk brake 1 is configured to generate a braking force based on driving of an electric motor 27 while a vehicle runs normally. In the following description, the present embodiments will be described, referring to the internal side of the vehicle (an inner side) as a one-end side and the external side of the vehicle (an outer side) as an opposite-end side as necessary. In other words, the present embodiments will be described, referring to the right side and the left side in FIGS. 1 and 2 as the one-end side and the opposite-end side, respectively, as necessary.

Referring to FIG. 1, the disk brake 1 according to the present embodiments includes a pair of inner and outer brake pads 2 and 3 and a caliper 4. The pair of inner and outer brake pads 2 and 3 is disposed on both the axial sides of a disk rotor D. The disk rotor D is mounted at a rotational portion of the vehicle. The present disk brake 1 is configured as a floating caliper-type disk brake. The pair of inner and out brake pads 2 and 3, and the caliper 4 are supported movably in the axial direction of the disk rotor D relative to a bracket 5 fixed to a non-rotational portion such as a knuckle of the vehicle. The disk rotor D corresponds to a braking receiving member. The pair of inner and outer brake pads 2 and 3 corresponds to a braking member.

Referring to FIG. 1, the caliper 4 includes a caliper main body 8 and a transmission mechanism 9. The caliper main body 8 is a main body of the caliper 4. The transmission mechanism 9 transmits a rotation fed from the electric motor 27 to a piston 18 in a cylinder portion 13 of the caliper main body 8, thereby applying a thrust force to this piston 18. The caliper main body 8 includes the cylindrical cylinder portion 13 and a pair of claw portions 14 and 14. The cylinder portion 13 is disposed on the proximal end side facing the inner brake pad 2, and is opened toward this inner brake pad 2. The pair of claw portions 14 and 14 extends from this cylinder portion 13 to the outer side across over the disk rotor D, and is disposed on the distal end side facing the outer brake pad 3.

The piston 18 is contained non-rotatably and axially movably relative to the cylinder portion 13 inside the cylinder portion 13 of the caliper main body 8, i.e., in a cylinder bore 16 of the cylinder portion 13. The piston 18 functions to press the inner brake pad 2, and is formed into a bottomed cupped shape. This piston 18 is contained in the cylinder bore 16 of the cylinder portion 13 in such a manner that the bottom portion thereof faces the inner brake pad 2. The piston 18 is supported non-rotatably relative to the cylinder bore 16 and thus the caliper main body 8 due to engagement prohibiting a rotation between the bottom portion of the piston 18 and the inner brake pad 2.

A seal member (not illustrated) is disposed in the cylinder bore 16 of the cylinder portion 13 on the inner peripheral surface thereof on the opposite-end side. Then, the piston 18 is contained in the cylinder bore 16 axially movably in a state in contact with this seal member. A dust boot 20 is interposed between the outer peripheral surface of the piston 18 on the bottom portion side thereof and the inner peripheral surface of the cylinder bore 16 on the opposite-end side thereof. The disk brake 1 is configured to prevent an entry of a foreign object into the cylinder bore 16 of the cylinder portion 13 with the aid of these seal member and dust boot 20. Further, a gear housing 25 is integrally coupled with a bottom wall 23 side (the one-end side) of the cylinder portion 13 of the caliper main body 8. The electric motor 27, a multi-stage spur gear speed reduction mechanism 29 and a planetary gear speed reduction mechanism 30, which will be described below, are disposed inside this gear housing 25. The opening of the gear housing 25 on the one-end side is closed by a cover member (not illustrated). This cover member is air-tightly attached to the gear housing 25.

The rotation from the electric motor 27 is transmitted to the piston 18 via a transmission mechanism 9. The transmission mechanism 9 includes the multi-stage spur gear speed reduction mechanism 29 and the planetary gear speed reduction mechanism 30, and a rotation-linear motion conversion mechanism 31. The multi-stage spur gear speed reduction mechanism 29 and the planetary gear speed reduction mechanism 30 power up a rotational torque fed from the electric motor 27. The rotation-linear motion conversion mechanism 31 converts a rotation fed from this planetary gear speed reduction mechanism 30 into a linear motion and applies a thrust force to the piston 18. The electric motor 27 is disposed in the gear housing 25, and a rotational shaft 27A thereof extends toward the one-end side. Referring to FIG. 2, the multi-stage spur gear speed reduction mechanism 29 includes a first speed reduction gear 34, a second speed reduction gear 35, and a third speed reduction gear 36. The second speed reduction gear 35 and the third speed reduction gear 36 are made from metal, or resin such as fiber-reinforced resin. The first speed reduction gear 34 corresponds to a first gear.

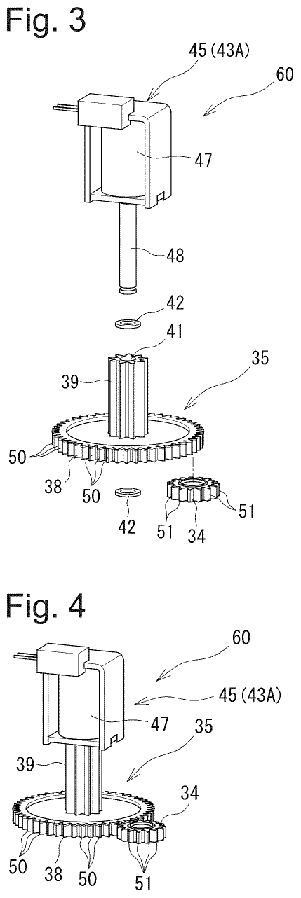

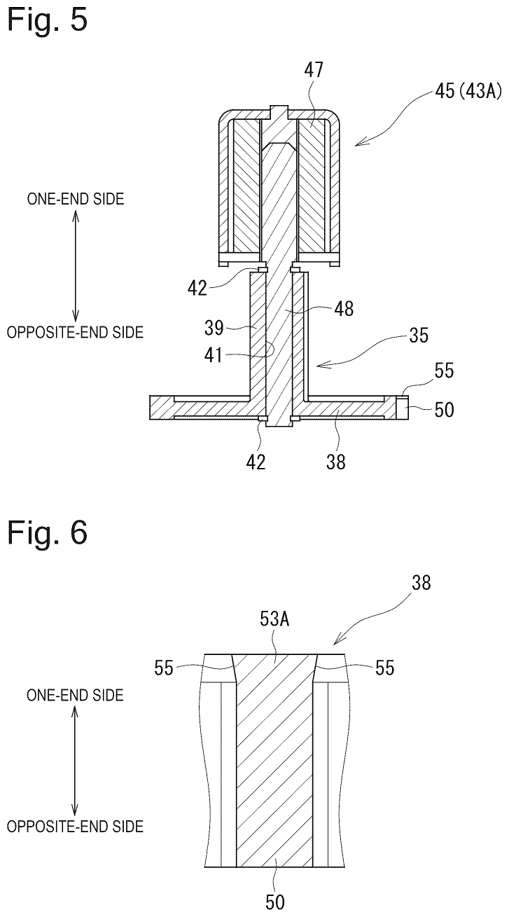

Referring to FIGS. 2 to 5, the first speed reduction gear 34 is cylindrically formed, and is fixedly press-fitted to the rotational shaft 27A of the electric motor 27. The second speed reduction gear 35 is formed by a stepped gear. This second speed reduction gear 35 includes a large-diameter gear 38 and a small-diameter gear 39. The large-diameter gear 38 is meshed with the first speed reduction gear 34, and is large in diameter. The small-diameter gear 39 extends axially from the large-diameter gear 38 toward the one-end side coaxially, and is small in diameter. The large-diameter gear 38 of the second speed reduction gear 35 corresponds to a second gear. In the following description, the configuration of a parking brake mechanism 60 including a switch mechanism 43A (a solenoid actuator 45) according to a first embodiment will be described. Referring to FIGS. 3 and 5, an attachment hole 41 is provided at the radial center of the second speed reduction gear 35. This attachment hole 41 extends through the second speed reduction gear 35 axially. A plunger 48 of the solenoid actuator 45 as the switch mechanism 43A according to the first embodiment is rotatably inserted in the attachment hole 41 of the second speed reduction gear 35.

A pair of retaining rings 42 and 42 is provided on the plunger 48 of the solenoid actuator 45 at positions where they sandwich the second speed reduction gear 35 from the axial direction thereof. The plunger 48 is restricted from axially moving relative to the second speed reduction gear 35 by this pair of retaining rings 42 and 42. Then, the second speed reduction gear 35 is rotatably supported by the plunger 48 of the solenoid actuator 45. A bi-directional latching type is employed as the solenoid actuator 45, and this type of actuator can hold the position of the plunger 48 using a permanent magnet after the plunger 48 advances or retracts. As a result, the parking brake mechanism 60 becomes able to maintain the parking state even after electric power supply to the solenoid actuator 45 is stopped after the parking brake is actuated. Referring to FIGS. 1 and 2, the solenoid actuator 45 is arranged with a main body portion 47 thereof positioned on the one-end side.

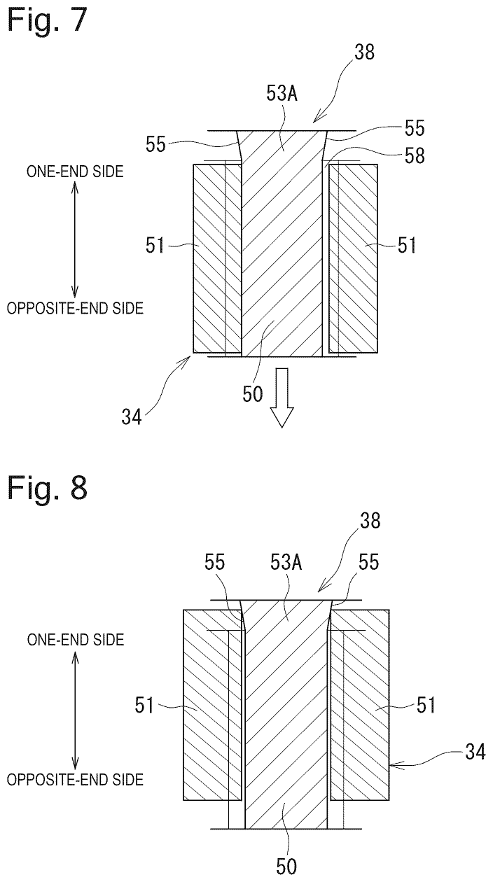

Referring to FIGS. 5 and 6, a tooth thickened portion 53A is formed on each tooth portion 50 of the large-diameter gear 38 of the second speed reduction gear 35 on a one-end side in the flank line direction. The tooth thickened portion 53A is formed to have a wider chordal tooth thickness. Also referring to FIG. 2, the one-end side in the flank line direction is the same as the one-end side of the disk brake 1, and is one side where the main body portion 47 of the solenoid actuator 45 is located. Referring to FIGS. 5 and 6, the tooth thickened portion 53A includes taper surfaces 55 and 55 formed on the both tooth flanks thereof, respectively. The taper surfaces 55 each have a chordal tooth thickness increasing toward the one end in the flank line direction. Referring to FIG. 8, the maximum chordal tooth thickness of the tooth thickened portion 53A is set to a value greater than the distance (the space width) between adjacent tooth portions 51 and 51 of the first speed reduction gear 34. Referring to FIGS. 7 and 8, the face width (the length in the flank line direction) of each tooth portion 50 of the large-diameter gear 38 of the second speed reduction gear 35 is set to a value greater than the face width (the length in the flank line direction) of the tooth portion 51 of the first speed reduction gear 34 by an amount corresponding to the face width of the tooth thickened portion 53A.

Then, referring to FIG. 7, under normal conditions where the solenoid actuator 45 is not actuated, each tooth portion 50 including the tooth thickened portion 53A in the large-diameter gear 38 of the second speed reduction gear 35 and each tooth portion 51 of the first speed reduction gear 34 are meshed with each other, and a gap 58 is generated between each tooth portion 50 of the large-diameter gear 38 of the second speed reduction gear 35 and each tooth portion 51 of the first speed reduction gear 34. As a result, each tooth portion 50 including the tooth thickened portion 53A in the large-diameter gear 38 of the second speed reduction gear 35 and each tooth portion 51 of the first speed reduction gear 34 can execute a slip effect to each other, and thus can transmit a rotational torque mutually.

On the other hand, referring to FIG. 8, when the parking brake is actuated, the solenoid actuator 45 is actuated and the plunger 48 advances (projects) to the opposite-end side, and therefore the second speed reduction gear 35 advances axially relative to the first speed reduction gear 34. Then, each tooth thickened portion 53A of the large-diameter gear 38 of the second speed reduction gear 35, more specifically, each of the taper surfaces 55 and 55 of each tooth thickened portion 53A and each tooth portion 51 of the first speed reduction gear 34 are brought into contact with each other, eliminating the above-described gap 58 therebetween. As a result, the second speed reduction gear 35 and the first speed reduction gear 34 are restricted from rotating, and the parking brake state is maintained.

Further, when the parking brake is released, the solenoid actuator 45 is actuated and the plunger 48 retracts to an initial state, thereby causing the second speed reduction gear 35 to retract axially relative to the first speed reduction gear 34. Then, as illustrated in FIG. 7, each tooth portion 50 including the tooth thickened portion 53A in the large-diameter gear 38 of the second speed reduction gear 35 and each tooth portion 51 of the first speed reduction gear 34 return to the initial state where the gap 58 is generated therebetween. As a result, each tooth portion 50 including the tooth thickened portion 53A in the large-diameter gear 38 of the second speed reduction gear 35 and each tooth portion 51 of the first speed reduction gear 34 are permitted to rotate.

The tooth thickened portion 53A is formed on each tooth portion 50 of the large-diameter gear 38 of the second speed reduction gear 35 in the present embodiment, but may be formed on each tooth portion 51 of the first speed reduction gear 34. In sum, the tooth thickened portion 53A is not limited to the above-described example as long as being provided to any one of each tooth portion 50 of the large-diameter gear 38 of the second speed reduction gear 35 and each tooth portion 51 of the first speed reduction gear 34. Further, the second speed reduction gear 35 is equipped with the solenoid actuator 45 (the switch mechanism 43A) and is configured to advance or retract relative to the first speed reduction gear 34 in the present embodiment, but the first speed reduction gear 34 may be equipped with the solenoid actuator 45 and be configured to advance or retract relative to the second speed reduction gear 35.

Further, the tooth thickened portion 53A may be formed on any one of tooth portions of gears meshed with each other that are different from the large-diameter gear 38 of the second speed reduction gear 35 (the first speed reduction gear 34), and the solenoid actuator 45 may be provided to either one or the other of these gears. Furthermore, the tooth thickened portion 53A is formed on each tooth portion 50 of the large-diameter gear 38 of the second speed reduction gear 35 on the one-end side in the flank line direction in the present embodiment, but may be provided on the opposite-end side in the tooth flank direction. In the case of this embodiment, the plunger 48 of the solenoid actuator 45 moves in a retraction direction (the one-end side) when the parking brake is actuated, and moves in a projection direction (the opposite-end side) when the parking brake is released. The parking brake mechanism 60 including the switch mechanism 43A (the solenoid actuator 45) according to the first embodiment is configured in this manner.

Referring to FIG. 2, the small-diameter gear 39 of the second speed reduction gear 35 is meshed with the third speed reduction gear 36. This third speed reduction gear 36 includes a large-diameter gear 62 and a sun gear 63. The large-diameter gear 62 is meshed with the small-diameter gear 39 of the second speed reduction gear 35, and is large in diameter. The sun gear 63 is coaxially provided inside the large-diameter gear 62, and is small in diameter. The sun gear 63 is configured as a part of the planetary gear speed reduction mechanism 30. An annular space 64 is formed between the inner peripheral surface of the large-diameter gear 62 of the third speed reduction gear 36 and the outer peripheral surface of the sun gear 63. One end of the large-diameter gear 62 and one end of the sun gear 63 are connected to each other via a disk-shaped wall portion 65. An annular stopper portion 66 is formed on the surface of this disk-shaped wall portion 65 on the opposite-end side at a position closer to the outer peripheral portion thereof. The stopper portion 66 protrudes toward the opposite-end side.

The planetary gear speed reduction mechanism 30 includes the sun gear 63 of the third speed reduction gear 36, a plurality of planetary gears 70 (five in the present embodiment), and an internal gear 71. Each of the planetary gears 70 includes a gear 75 and a hole portion 76. The gear 75 is meshed with the sun gear 63 and internal teeth 78 of the internal gear 71. A pin 90 erected from a carrier 72, which will be described below, is rotatably inserted through the hole portion 76. The planetary gears 70 are each arranged at circumferentially even intervals around the sun gear 63, More specifically, the planetary gears 70 are arranged at circumferentially even intervals on the inner side of the internal teeth 78 of the internal gear 71, which will be described below, in the annular space 64 between the inner peripheral surface of the large-diameter gear 62 of the third speed reduction gear 36 and the outer peripheral surface of the sun gear 63. The gear 75 of each of the planetary gears 70 is meshed with the sun gear 63 and the internal teeth 78 of the internal gear 71.

The internal gear 71 includes the internal teeth 78, an annular wall portion 79, and a cylindrical wall portion 80. The internal teeth 78 are meshed with the gears 75 of the planetary gears 70, respectively. The annular wall portion 79 radially centrally extends continuously from one end of these internal teeth 78 and restricts an axial movement of each of the planetary gears 70. The cylindrical wall portion 80 extends from the opposite-side surface near the internal teeth 78 toward the opposite-end side. The portion of the internal gear 71 where the internal teeth 78 are formed is disposed between the inner peripheral surface of the large-diameter gear 62 of the third speed reduction gear 36 and each of the planetary gears 70. Then, the third speed reduction gear 36 is supported rotatably relative to the internal gear 71. The annular wall portion 79 of the internal gear 71 is disposed between each of the planetary gears 71 and the disk-shaped wall portion 65 of the third speed reduction gear 36. The internal gear 71 employs this cylindrical wall portion 80 and the like, and further employs, for example, abutment of the annular stopper portion 66 provided on the disk-shaped wall portion 65 of the third speed reduction gear 36 with the one-end surface of the internal gear 71, thereby being restricted from moving radially and axially and also supported non-rotatably relative to the gear housing 25.

A rotation from the planetary gear speed reduction mechanism 30, i.e., a rotation from each of the planetary gears 70 is transmitted to the carrier 72. The carrier 72 is formed into a disk shape. A plurality of pin hole portions 89 is formed on the outer peripheral portion of the carrier 72 at circumferential intervals in correspondence with the planetary gears 70, respectively. The pins 90 are fixedly press-fitted in the pin hole portions 89, respectively. The pins 90 are rotatably inserted through the hole portions 76 of the planetary gears 70, respectively. A spindle 93 is coupled with the carrier 72 relatively non-rotatably. The spindle 93 is configured to receive a rotation from the carrier 72 and transmit a rotational torque thereof to the rotation-linear motion conversion mechanism 31.

Referring to FIG. 1, the rotation-linear motion conversion mechanism 31 is configured to convert the rotational motion fed from the multi-stage spur gear speed reduction mechanism 29 and the planetary gear speed reduction mechanism 30, i.e., the rotational motion fed from the spindle 93 into a straight-line motion (hereinafter referred to as a linear motion for convenience), thereby applying the thrust force to the piston 18 using a movement of a linear motion member thereof (not illustrated). The rotation-linear motion conversion mechanism 31 is disposed in the cylinder bore 16 between the bottom surface thereof and the piston 18. Then, when the spindle 93 rotates according to the rotation of the carrier 72, the rotation-linear motion conversion mechanism 31 causes the linear motion member thereof to advance toward the opposite-end side, thereby causing this piston 18 to advance and thus being able to press the inner brake pad 2 against the disk rotor D using this piston 18. A screw mechanism, a ball screw mechanism, a ball and ramp mechanism, or the like is employed as the rotation-linear motion conversion mechanism.

The driving of the electric motor 27 illustrated in FIG. 1 is controlled according to an instruction from a control board (not illustrated). When the vehicle is braked while running normally, the driving of the electric motor 27 is controlled by this control board based on a detection signal from a detection sensor that responds to a driver's request (not illustrated), various detection sensors that detect various situations requiring the brake (not illustrated), or the like, and detection signals from a rotational angle detector (not illustrated), a thrust force sensor (not illustrated), and the like. Further, this control board is electrically connected to a parking brake switch (not illustrated), and the actuation of the solenoid actuator 45 is controlled according to an instruction from the control board.

Next, braking and braking release operations while the vehicle runs normally, which are performed in the disk brake 1 according to the present embodiment, will be described.

When the vehicle is braked while running normally, the electric motor 27 is driven according to an instruction from the control board, and a rotation thereof in a forward direction, i.e., a braking direction is transmitted to the sun gear 63 of the planetary gear speed reduction mechanism 30 via the multi-stage spur gear speed reduction mechanism 29. The rotation of the sun gear 63 of this planetary gear speed reduction mechanism 30 causes each of the planetary gears 70 to revolve around the rotational axis of the sun gear 63 while rotating around its own rotational axis, thereby causing the carrier 72 to rotate. In other words, the rotation from the electric motor 27 is transferred to the carrier 72 after being slowed down at a predetermined speed reduction ratio and powered up by being transmitted via the multi-stage spur gear speed reduction mechanism 29 and the planetary gear speed reduction mechanism 30. Then, the rotation from the carrier 72 is transmitted to the spindle 93.

Subsequently, when the spindle 93 rotates according to the rotation of the carrier 72, the action of the rotation-linear motion conversion mechanism 31 causes the linear motion member thereof to advance, thereby causing the piston 18 to advance. Due to the advancement of this piston 18, the inner brake pad 2 is pressed against the disk rotor D. Then, due to a reaction force to the pressing force from the piston 18 to the inner brake pad 2, the caliper main body 8 moves to the inner side (the one-end side) relative to the bracket 5, thereby pressing the outer brake pad 3 against the disk rotor D using each of the claw portions 14 and 14. As a result thereof, a frictional force is generated with the disk rotor D sandwiched by the pair of inner and outer brake pads 2 and 3, and this eventually leads to generation of a braking force on the vehicle.

On the other hand, when the braking is released, the electric motor 27 is driven according to an instruction from the control board, and a rotation thereof in a reverse direction, i.e., a braking release direction is transmitted to the spindle 93 via the multi-stage spur gear speed reduction mechanism 29, the planetary gear speed reduction mechanism 30, and the carrier 72. As a result, the action of the rotation-linear motion conversion mechanism 31 causes the linear motion member thereof to retract to return to the initial state according to the rotation of the spindle 93 in the reverse direction, thereby releasing the braking force applied from the pair of inner and outer brake pads 2 and 3 to the disk rotor D.

Next, the actuation of the parking brake in the disk brake 1 according to the present invention will be described.

When the parking brake switch is operated, the electric motor 27 is driven according to an instruction from the control board, and a rotation thereof in the forward direction, i.e., the braking direction is transmitted to the carrier 72 via the multi-stage spur gear speed reduction mechanism 29 and the planetary gear speed reduction mechanism 30, similarly to the operation at the time of the normal braking. Subsequently, when the spindle 93 rotates according to the rotation fed from the carrier 72, the action of the rotation-linear motion conversion mechanism 31 causes the piston 18 to advance, thereby causing the disk rotor D to be sandwiched by the pair of inner and outer brake pads 2 and 3 and the braking force to be generated.

The plunger 48 of the solenoid actuator 45 advances due to electric power supply to the solenoid actuator 45 according to an instruction from the control board in this state. As a result, the second speed reduction gear 35 advances axially relative to the first speed reduction gear 34 to bring each tooth thickened portion 53A (each of the taper surfaces 55 and 55) of the large-diameter gear 38 of the second speed reduction gear 35 and each tooth portion 51 of the first speed reduction gear 34 into contact with each other without a gap, i.e., the gap 58 generated therebetween. As a result, the second speed reduction gear 35 and the first speed reduction gear 34 do not rotate even when a rotational torque in the braking release direction is transmitted to the second speed reduction gear 35 as a reaction force between the disk rotor D and the inner and outer brake pads 2 and 3 after the braking force is generated. Then, after the electric power supply to the electric motor 27 is stopped and the pressing force of the pair of inner and outer brake pads 2 and 3 to the disk rotor D is confirmed, the electric power supply to the solenoid actuator 45 is stopped.

Then, since the bi-directional latching type employed as the solenoid actuator 45 can hold the position of the plunger 48 using a permanent magnet, each tooth thickened portion 53A of the large-diameter gear 38 of the second speed reduction gear 35 and each tooth portion 51 of the first speed reduction gear 34 are kept in the state in contact with each other without the gap 58 generated therebetween, and the second speed reduction gear 35 and the first speed reduction gear 34 are kept in the state restricted from rotating even when the electric power supply to the solenoid actuator 45 is stopped. Due to that, the parking brake mechanism 60 can maintain the braking state with the electric power supply stopped for the electric motor 27 and the solenoid actuator 45, thereby completing the actuation of the parking brake.

Next, when the parking brake is released, the plunger 48 of the solenoid actuator 45 is controlled to retract to the initial position by supplying electric power to the solenoid actuator 45 according to an instruction from the control board. As a result, each tooth portion 50 including the tooth thickened portion 53A in the large-diameter gear 38 of the second speed reduction gear 35 and each tooth portion 51 of the first speed reduction gear 34 return to the initial state where the gap 58 is generated therebetween. After that, the rotational shaft 27A of the electric motor 27 rotates in the reverse direction, i.e., the braking release direction according to an instruction from the control board, and this rotation in the reverse direction is also transmitted to the spindle 93 via the multi-stage spur gear speed reduction mechanism 29, the planetary gear speed reduction mechanism 30, and the carrier 72. As a result, the linear motion member of the rotation-linear motion conversion mechanism 31 retracts to return to an initial state, and the braking force applied from the pair of inner and outer brake pads 2 and 3 to the disk rotor D is released.

The parking brake mechanism 60 may perform control of actuating the parking brake using the electric motor 27 in the above-described manner again while de-actuating the parking brake using the solenoid actuator 45 as necessary after a predetermined time has elapsed since the parking brake is actuated due to the actuation of the electric motor 27 and the solenoid actuator 45 according to an instruction from the control board (also referred to as a re-clamping operation). This can prevent a reduction in the thrust force of the parking brake that might occur due to thermal contraction of the inner and outer brake pads 2 and 3 and the disk rotor D according to a temperature reduction when the parking brake is actuated under a high temperature immediately after the vehicle is braked.

In the above-described manner, the parking brake mechanism 60 provided to the disk brake 1 according to the present embodiment includes the solenoid actuator 45 serving as the switch mechanism 43A that moves the second speed reduction gear 35 and the first speed reduction gear 34 relative to each other along the axial direction thereof, more specifically, move the second speed reduction gear 35 relative to the first speed reduction gear 34 along the axial direction thereof, and is configured to generate or eliminate the gap 58 between the tooth thickened portion 53A of the large-diameter gear 38 of the second speed reduction gear 35 and each tooth portion 51 of the first speed reduction gear 34 by actuating this solenoid actuator 45.

As a result, the parking brake mechanism 60 provided to the disk brake 1 according to the present embodiment eliminates the necessity of actuating the solenoid actuator and the electric motor in a stepwise manner to align the gear portion of the ratchet gear and the claw portion of the holding member unlike the conventional technique (the technique disclosed in PTL 1), thereby being able to actuate the parking brake in a stepless manner and achieving excellent controllability. Further, the ratchet gear, the holding member, the engagement member, the compression coil spring, and the like do not have to be provided as the parking brake mechanism unlike the conventional technique, and thus the structure and the layout thereof can be significantly simplified and a size reduction can be achieved.

Further, conventionally, parking brakes employing a frictional force using a clutch mechanism have been available, but the frictional force is affected by a large number of variation factors such as surface roughness, deformation, and a surface condition at the contact portion, environmental conditions, and a degradation state over time, thus posing a problem in terms of ensuring highly robust reliability. On the other hand, the parking brake mechanism 60 according to the present embodiment is configured to bring the tooth thickened portion 53A of the large-diameter gear 38 of the second speed reduction gear 35 and each tooth portion 51 of the first speed reduction gear 34 into contact with each other without the gap 58 generated therebetween by actuating the solenoid actuator 45, thereby improving the safety and the reliability without relying on uncertainties difficult to manage, such as the frictional force.

Further, the parking brake mechanism 60 provided to the disk brake 1 according to the present embodiment includes the solenoid actuator 45 as the switch mechanism 43A that moves the second speed reduction gear 35 in the axial direction thereof, and the bi-directional latching type employed as this solenoid actuator 45 can hold the position of the plunger 48 using a permanent magnet even when electric power supply is stopped after the operation. Therefore, the parking brake mechanism 60 can avoid such a malfunction that the parking brake is accidentally actuated due to, for example, a running vibration.

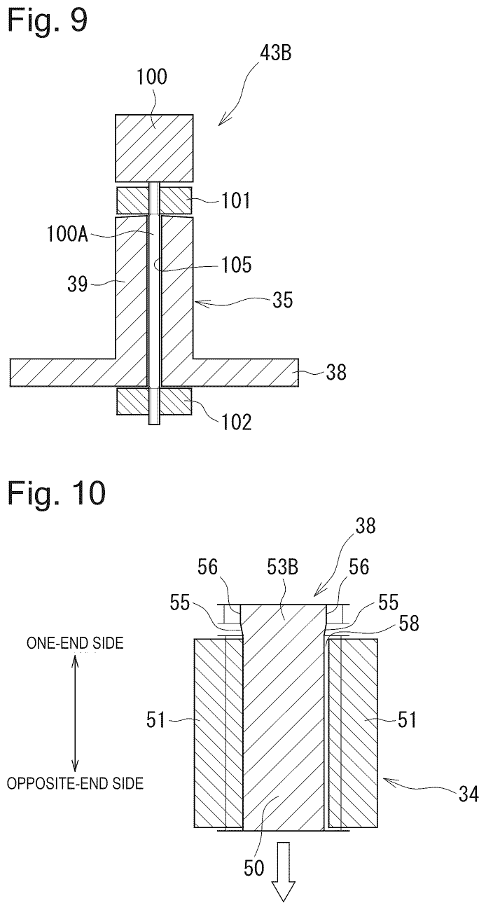

Next, a switch mechanism 43B according to a second embodiment will be described with reference to FIG. 9. The switch mechanism 43B according to the second embodiment includes an electric motor 100 and a pair of first and second nut members 101 and 102. The electric motor 100 includes a rotational shaft 100A. The first and second nut members 101 and 102 are each threadedly engaged with the rotational shaft 100A, and position the second speed reduction gear 35 by sandwiching it from both the axial sides. More specifically, the first nut member 101 is disposed on the one-end side of the small-diameter gear 39 of the second speed reduction gear 35. On the other hand, the second nut member 102 is disposed on the opposite-end side of the large-diameter gear 38 of the second speed reduction gear 35. The first and second nut members 101 and 102 are restricted from rotating.

A support hole 105 is provided at the radial center of the second speed reduction gear 35. The support hole 105 extends through the second speed reduction gear 35 axially. The rotational shaft 100A of the electric motor 100 is rotatably inserted through the support hole 105 of the second speed reduction gear 35. Then, when the electric motor 100 is actuated to rotate the rotational shaft 100A in the forward direction or the reverse direction, each of the first and second nut members 101 and 102 advances or retracts, and therefore the second speed reduction gear 35 advances or retracts axially according thereto. The first and second nut members 101 and 102 are threadedly engaged with the rotational shaft 100A via the screw mechanism in the present embodiment, but another known rotation-linear motion conversion mechanism, such as a ball screw mechanism or a roller screw mechanism, may be employed.

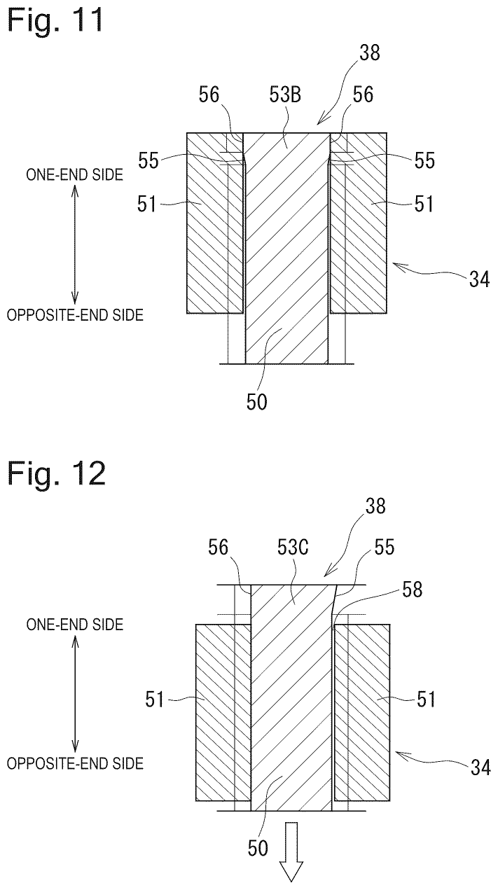

Next, a tooth thickened portion 53B according to another embodiment, which is provided to each tooth portion 50 of the large-diameter gear 38 of the second speed reduction gear 35, will be described with reference to FIGS. 10 and 11. This tooth thickened portion 53B includes the taper surfaces 55 and base surfaces 56 on both the tooth flanks thereof, respectively. The taper surfaces 55 each have a chordal tooth thickness increasing toward one end in the flank line direction. The base surfaces 56 each extend along the flank line direction continuously from the one end of this taper surface 55 in the flank line direction. The maximum chordal tooth thickness of the tooth thickened portion 53B, i.e., the distance between the pair of base surfaces 56 and 56 provided on both the tooth flanks of the tooth thickened portion 53B, respectively, approximately matches the distance (the space width) between the adjacent tooth portions 51 and 51 of the first speed reduction gear 34.

Then, when the parking brake is actuated, referring to FIG. 11, the solenoid actuator 45 is actuated and the second speed reduction gear 35 advances axially relative to the first speed reduction gear 34, and this brings each tooth thickened portion 53B of the large-diameter gear 38 of the second speed reduction gear 35, more specifically, the pair of base surfaces 56 and 56 of each tooth thickened portion 53B and each tooth portion 51 of the first speed reduction gear 34 into a state in contact with each other without the gap 58 generated therebetween. As a result, each tooth thickened portion 53B of the large-diameter gear 38 of the second speed reduction gear 35 and each tooth portion 51 of the first speed reduction gear 34 are kept in the state in contact with each other without the gap 58 generated therebetween, and the second speed reduction gear 35 and the first speed reduction gear 34 are kept in the state restricted from rotating even when the electric power supply to the solenoid actuator 45 is stopped. Due to that, the parking brake mechanism 60 can maintain this braking state with the electric power supply stopped for the electric motor 27 and the solenoid actuator 45.

The tooth thickened portion 53A illustrated in FIGS. 6 to 8 has a large number of variation factors such as a change over time and deformation due to wear at the contact portion between each of the taper surfaces 55 of the tooth thickened portion 53A and each tooth portion 51 of the first speed reduction gear 34, environmental conditions, and degradation over time, and this slightly complicates the control of the stroke amount of the plunger 48 of the solenoid actuator 45 for holding the parking brake. On the other hand, the tooth thickened portion 53B illustrated in FIGS. 10 and 11 can reduce the influence of the above-described variation factors with the aid of the provision of the pair of base surfaces 56 and 56, thereby contributing to simplification of the control of the stroke amount of the plunger 48 of the solenoid actuator 45 for holding the parking brake. In addition, the tooth thickened portion 53B illustrated in FIGS. 10 and 11 can reduce the influence of the above-described variation factors with the aid of the provision of the pair of base surfaces 56 and 56, thereby also reducing the thrust force required for the solenoid actuator 45 and thus achieving a size reduction.

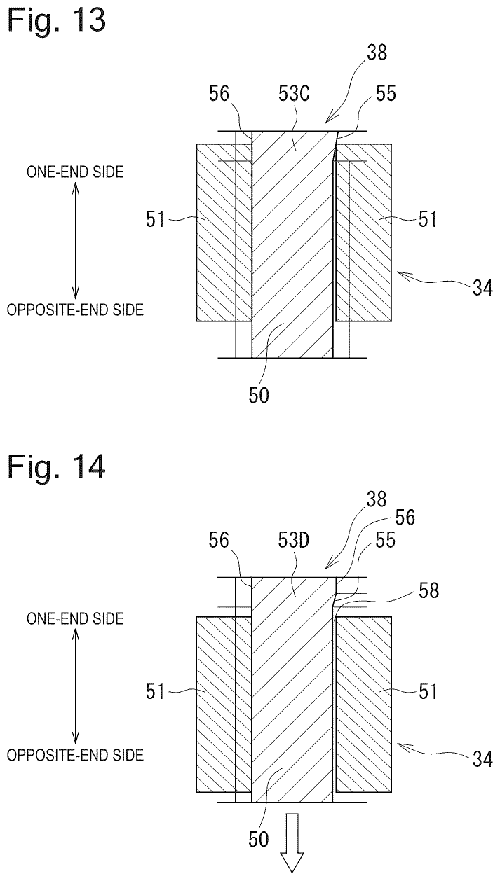

Next, a tooth thickened portion 53C according to further another embodiment, which is provided to each tooth portion 50 of the large-diameter gear 38 of the second speed reduction gear 35, will be described with reference to FIGS. 12 and 13. One of the flanks of the entire tooth portion 50 including this tooth thickened portion 53C to which a rotation is transmitted from the electric motor 27 when the parking brake is actuated is formed by the base surface 56 extending along the flank line direction. Further, the other of the flanks of this tooth thickened portion 53C is formed by the taper surface 55 having a chordal tooth thickness increasing toward one end in the flank line direction. The maximum chordal tooth thickness of the tooth thickened portion 53C is set to a value greater than the distance (the space width) between the adjacent tooth portions 51 and 51 of the first speed reduction gear 34.

Then, when the parking brake is actuated, referring to FIG. 13, the solenoid actuator 45 is actuated and the second speed reduction gear 35 advances axially relative to the first speed reduction gear 34, and this brings each tooth thickened portion 53C of the large-diameter gear 38 of the second speed reduction gear 35, more specifically, the base surface 56 and the taper surface 55 of each tooth thickened portion 53C and each tooth portion 51 of the first speed reduction gear 34 into a state in contact with each other without the gap 58 generated therebetween. As a result, each tooth thickened portion 53C of the large-diameter gear 38 of the second speed reduction gear 35 and each tooth portion 51 of the first speed reduction gear 34 are kept in the state in contact with each other without the gap 58 generated therebetween, and the second speed reduction gear 35 and the first speed reduction gear 34 are kept in the state restricted from rotating even when the electric power supply to the solenoid actuator 45 is stopped. Due to that, the parking brake mechanism 60 can maintain this braking state with the electric power supply stopped for the electric motor 27 and the solenoid actuator 45.

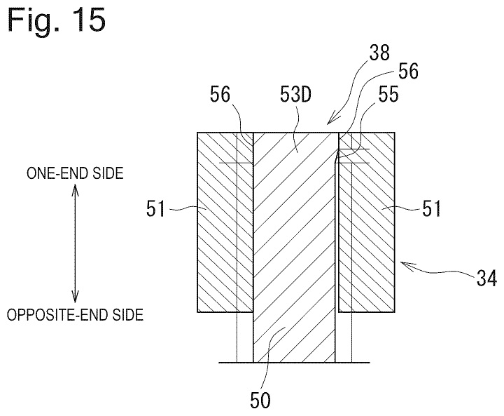

Next, a tooth thickened portion 53D according to further another embodiment, which is provided to each tooth portion 50 of the large-diameter gear 38 of the second speed reduction gear 35, will be described with reference to FIGS. 14 and 15. One of the flanks of the entire tooth portion 50 including this tooth thickened portion 53D to which a rotation is transmitted from the electric motor 27 when the parking brake is actuated is formed by the base surface 56 extending along the flank line direction. Further, the other of the flanks of this tooth thickened portion 53D includes the taper surface 55 and the base surface 56. The taper surface 55 has a chordal tooth thickness increasing toward one end in the flank line direction. The base surface 56 extends along the flank line direction continuously from the one end of this taper surface 55 in the flank line direction. The maximum chordal tooth thickness of the tooth thickened portion 53D, i.e., the distance between the pair of base surfaces 56 and 56 provided on both the tooth flanks of the tooth thickened portion 53D, respectively, approximately matches the distance (the space width) between the adjacent tooth portions 51 and 51 of the first speed reduction gear 34.

Then, when the parking brake is actuated, referring to FIG. 15, the solenoid actuator 45 is actuated and the second speed reduction gear 35 advances axially relative to the first speed reduction gear 34, and this brings each tooth thickened portion 53D of the large-diameter gear 38 of the second speed reduction gear 35, more specifically, the pair of base surfaces 56 and 56 of each tooth thickened portion 53D and each tooth portion 51 of the first speed reduction gear 34 into a state in contact with each other without the gap 58 generated therebetween. As a result, each tooth thickened portion 53D of the large-diameter gear 38 of the second speed reduction gear 35 and each tooth portion 51 of the first speed reduction gear 34 are kept in the state in contact with each other without the gap 58 generated therebetween, and the second speed reduction gear 35 and the first speed reduction gear 34 are kept in the state restricted from rotating even when the electric power supply to the solenoid actuator 45 is stopped. Due to that, the parking brake mechanism 60 can maintain this braking state with the electric power supply stopped for the electric motor 27 and the solenoid actuator 45.

In the above-described manner, on the tooth thickened portion 53C illustrated in FIGS. 12 and 13 and the tooth thickened portion 53D illustrated in FIGS. 14 and 15, the flank of the entire tooth portion 50 (50) including the tooth thickened portion 53C (53D) to which a rotation is transmitted from the electric motor 27 when the parking brake is actuated is formed by the base surface 56 (56) extending along the flank line direction. Therefore, when the parking brake is actuated, the base surface 56 of the entire tooth portion 50 (50) including the tooth thickened portion 53C (53D) and the tooth portion 51 of the first speed reduction gear 34 can perform a stepless linear motion when the electric motor 27 is driven in the braking direction, and this can reduce the thrust force of the solenoid actuator 45 required to actuate the parking brake. Further, actuating the solenoid actuator 45 while rotating the electric motor 27 allows the parking brake mechanism 60 to further reduce the thrust force of the solenoid actuator 45 and smoothly power up the parking brake.

On the other hand, when the parking brake is released, the base surface 56 of the entire tooth portion 50 (50) including the tooth thickened portion 53C (53D) and the tooth portion 51 of the first speed reduction gear 34 are also in a state capable of performing a stepless linear motion, and this can reduce the thrust force of the solenoid actuator 45 required to actuate the parking brake. Further, actuating the solenoid actuator 45 while rotating the electric motor 27 allows the parking brake mechanism 60 to further reduce the thrust force of the solenoid actuator 45 and smoothly power down the parking brake.

The present embodiments have been described above assuming that they are employed for the disk brake I serving as the electric brake apparatus that generates a braking force based on driving of the electric motor 27 when the vehicle is braked while running normally, but the present embodiments may be employed for a disk brake as an electric brake apparatus that is configured in the following manner. When the vehicle is braked while running normally, the disk brake causes the piston 18 to advance based on a brake hydraulic pressure supplied into the cylinder bore 16 of the caliper main body 8, thereby generating a braking force using the pair of inner and outer brake pads 2 and 3. Only at the time of parking brake when, for example, the vehicle is parked, the disk brake transmits the rotation from the electric motor 27 to the piston 18 via the multi-stage spur gear speed reduction mechanism 29, the planetary gear speed reduction mechanism 30, and the rotation-linear motion conversion mechanism 31 to thus advance this piston 18, thereby generating the braking force using the pair of inner and outer brake pads 2 and 3.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2023-102521 filed on Jun. 22, 2023. The entire disclosure of Japanese Patent Application No. 2023-102521 filed on Jun. 22, 2023 including the specification, the claims, the drawings, and the abstract is incorporated herein by reference in its entirety.

### REFERENCE SIGNS LIST

1 disk brake (electric brake apparatus)
2 inner brake pad (braking member)
3 outer brake pad (braking member)
29 multi-stage spur gear speed reduction mechanism (speed reduction mechanism)
34 first speed reduction gear (first gear)
35 second speed reduction gear
38 large-diameter gear (second gear)
43A, 43B switch mechanism
50 tooth portion
45 solenoid actuator (switch mechanism)
51 tooth portion
53A to 53D tooth thickened portion
55 taper surface
56 base surface
58 gap
60 parking brake mechanism
D disk roto (braking receiving member)

1. An electric brake apparatus comprising:
an electric motor;
a speed reduction mechanism configured to power up a rotational torque fed from the electric motor; and
a parking brake mechanism configured to hold a pressing force for pressing a braking member toward a braking receiving member by converting a rotation fed from the speed reduction mechanism into a linear motion,
wherein the speed reduction mechanism includes a first gear and a second gear meshed with the first gear,
wherein a gap is generated along a rotational direction between a tooth portion of the first gear and a tooth portion of the second gear,
wherein the parking brake mechanism includes a switch mechanism configured to move the first gear and the second gear relative to each other along an axial direction thereof, and
wherein the electric brake apparatus is configured to generate or eliminate the gap based on actuation of the switch mechanism.

2. The electric brake apparatus according to claim 1, wherein the parking brake mechanism includes a tooth thickened portion formed on at least any one of the first gear and the second gear at an end portion in a flank line direction, the tooth thickened portion being formed to have a larger chordal tooth thickness.

3. The electric brake apparatus according to claim 2, wherein the tooth thickened portion includes a taper surface where the chordal tooth thickness thereof gradually increases toward one end.

4. The electric brake apparatus according to claim 3, wherein the tooth thickened portion includes a base surface extending along the flank line direction continuously from one end of the taper surface in the flank line direction.

5. The electric brake apparatus according to claim 3, wherein a flank of the entire tooth portion including the tooth thickened portion to which the rotation is transmitted from the electric motor when a parking brake is actuated is formed by the base surface extending along the flank line direction.

6. The electric brake apparatus according to claim 4, wherein a flank of the entire tooth portion including the tooth thickened portion to which the rotation is transmitted from the electric motor when a parking brake is actuated is formed by the base surface extending along the flank line direction.
